(19) United States
(12) Patent Application Publication
(10) Pub. No.: US 2014/0308175 A1
(43) Pub. Date: Oct. 16, 2014

(54) CATALYTIC COMBUSTOR IN GAS TURBINE ENGINE

(71) Applicant: KAWASAKI JUKOGYO KABUSHIKI KAISHA, Kobe-shi (JP)

(72) Inventors: Yasushi DOURA, Kobe-shi (JP); Masahiro OGATA, Kobe-shi (JP)

(73) Assignee: KAWASAKI JUKOGYO KABUSHIKI KAISHA, Kobe-shi (JP)

(21) Appl. No.: 14/316,344

(22) Filed: Jun. 26, 2014

Related U.S. Application Data
(63) Continuation of application No. PCT/JP2012/081996, filed on Dec. 11, 2012.

(30) Foreign Application Priority Data
Dec. 27, 2011 (JP) 2011-285245

(51) Int. Cl. B01D 53/94

(52) U.S. Cl. CPC B01D 53/94
USPC 422/176; 422/168

(57) ABSTRACT

A catalytic combustor (2) in a gas turbine engine (GT) includes a casing (54) for accommodating a catalyst carrier (10) therein, a catalyst retaining body (62) interposed between the casing (54) and the catalyst carrier (10) for retaining an outer peripheral surface of the catalyst carrier (10) to an inner peripheral surface of the casing (54) and also for preventing a gas (G2) from leaking in a downstream direction through an outer periphery of the catalyst carrier (10), a support material (64) disposed on a downstream side of the direction of flow of the gas to be treated in the catalyst carrier (10) for holding the catalyst carrier (10), and a downstream side regulating member (72) disposed on the downstream side of the catalyst retaining body (62) for avoiding a movement of the catalyst retaining body (62) in a direction of flow of the gas (G2).

### CROSS REFERENCE TO THE RELATED APPLICATION

This application is a continuation application, under 35 U.S.C §111(a) of international application No. PCT/JP2012/081996, filed Dec. 11, 2012, which claims priority to Japanese patent application No. 2011-285245, filed Dec. 27, 2011, the entire disclosure of which is herein incorporated by reference as a part of this application.

### BACKGROUND OF THE INVENTION

(1. Field of the Invention)

The present invention relates to a catalytic combustor used with a gas turbine engine and having a large catalyst sectional area.

(2. Description of Related Art)

The catalytic combustor mounted on the gas turbine engine has advantages in that, inter alia, no NOx is substantially emitted and methane of a concentration so low as to be unable to combust can be oxidized and is one of numerous technologies that can be addressed to the environment related issue such as low pollution and global warming. In this respect, see, for example, the patent document 1 listed below.

### PRIOR ART LITERATURE

Patent Document 1: Japanese Patent No. 4841679

The combustion catalyst used with the gas turbine engine that produces a large amount of gases to be treated by the catalyst requires the speed, at which the gases to be treated flows across the catalyst, to be so low that the large amount of the gases to be treated can be sufficiently reacted, and, therefore, the sectional area of the catalyst tends to be large. If the sectional area of the catalyst is increased, the cylindrical catalytic combustor is required to have a large diameter and, on the other hand, the strength of the catalyst carrier carrying the catalyst is lowered.

In general, when the catalyst is incorporated in a device, a catalyst retaining material is interposed between a casing of the catalyst combustor and the catalyst carrier. The catalyst retaining material concurrently serves to retain the catalyst carrier from its outer periphery and alto to function as a seal for preventing the gases to be treated from flowing to the outside of the catalyst. In order to prevent the catalyst retaining material from being departed by the effect of the flow of the gases to be treated, the catalyst retaining material is elastically and radially inwardly narrowed down to permit a predetermined preload to be applied in a radially inward direction and is held in contact with an inner surface of the casing by the effect of its elastic restoring force. At this time, as a result of the narrowing of the catalyst retaining material, a force acting in a centripetal direction is applied to the catalyst carrier, but in the case of a catalyst carrier having a large diameter, the catalyst carrier may be often deformed by the effect of this force.

### SUMMARY OF THE INVENTION

The present invention has been devised in view of the forgoing problems and inconveniences and is intended to provide a catalytic combustor for use with a gas turbine engine, in which an undesirable displacement of the catalyst retaining material in a direction conforming to the direction of flow of the gases to be treated is avoided while an undesirable deformation of the catalyst carrier by the effect of the preload is suppressed.

In order to accomplish the foregoing object, the present invention provides a catalytic combustor for use with the gas turbine engine which includes a casing to accommodate therein a catalyst carrier, a catalyst retaining body interposed between the casing and the catalyst carrier, which catalyst retaining body retains an outer peripheral surface of the catalyst carrier against an inner peripheral surface of the casing and also prevents gases to be treated from leaking in a downstream direction through an outer periphery of the catalyst carrier, a support material disposed on an downstream side of the catalyst carrier in a direction conforming to the direction of flow of the gases to be treated, which support material supports the catalyst carrier, and a downstream side regulating member disposed on a downstream side of the catalyst retaining body, which downstream side regulating member prevents the catalyst retaining body from moving in the direction of flow of the gases.

Since in the gas turbine engine the gas to be treated, which flows across the catalyst carrier, is generally under a high pressure, a considerable difference in pressure is developed between upstream and downstream sides of the finely meshed catalyst carrier. However, according to the present invention, even though the catalyst carrier and the catalyst retaining body are urged by the effect of the pressure difference in the direction of flow of the gas, it is possible to avoid the movement of the catalyst carrier and the catalyst retaining body in the direction of flow of the gas by the support material and the downstream side regulating member. Accordingly, there is no need to apply the preload to the catalyst retaining body by strongly narrowing the catalyst retaining body and allowing it to contact with the inner peripheral surface of the main body by the effect of the elastic restoring force in order to prevent the movement of the catalyst carrier and the catalyst retaining body. As a result thereof, it is also possible to avoid an undesirable deformation of the catalyst carrier which would otherwise occur when the catalyst retaining body is strongly narrowed.

In a preferred embodiment of the present invention, the downstream side regulating member may be annular in shape and the catalyst carrier may be columnar in shape, in which case the downstream side regulating member has an inner diameter that is substantially equal to the outer diameter of the catalyst carrier. According to this structural feature, with the downstream side regulating member brought into contact with a lower portion of the outer peripheral surface of the catalyst carrier, the catalyst carrier can be positioned.

In another preferred embodiment of the present invention, the downstream side regulating member preferably includes first and second regulating member halves that are divided into two in a peripheral direction, each of the first and second regulating member halves being disposed in face to face relation to each other while spaced circumferentially. Alternatively, the downstream side regulating member may have a cutout defined in a portion thereof in a circumferential direction and a circumferential gap may be provided in the cutout. The provision of the gap is effective to accommodate a thermal expansion of a ring body, which is disposed on the downstream of the catalyst tending to be heated to a high temperature.

In a further preferred embodiment of the present invention, the use is preferably made of an upstream side regulating member disposed on an upstream side of the catalyst retaining body in the direction of flow of the gases, in which case the upstream side regulating member operates to avoid a passage of the gases to be treated within the catalyst retaining body. While the upstream side regulating member is so designed and so configured as to have a shape and a size both sufficient to allow it to cover the substantially entire surface of an upstream end face of the catalyst retaining body, the inner diameter of the upstream regulating member is preferably so chosen as to be somewhat smaller than the outer diameter of the catalyst carries so that the inflow of the gas to be treated into the catalyst can be avoided as much as possible. According to this structural feature, the upstream side regulating member serves to prevent the gas to be treated from directly impinging upon the catalyst retaining body to thereby avoid a force in the direction of flow of the gas, from acting on the catalyst retaining body and also to prevent the catalyst retaining body from dropping out towards the upstream side of the direction of flow of the gas, in the event of the occurrence of a surging in the gas turbine engine.

In a still further preferred embodiment of the present invention, the casing is preferably removably supported inside of a hollow combustor housing. According to this structural feature, after removing the casing from the housing, replacement of the catalyst carrier can be accomplished by removing the catalyst carrier from the casing in the outside of the housing, a work to replace the catalyst carrier can be eased.

Any combination of at least two constructions, disclosed in the appended claims and/or the specification and/or the accompanying drawings should be construed as included within the scope of the present invention. In particular, any combination of two or more of the appended claims should be equally construed as included within the scope of the present invention.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a schematic structural diagram showing a gas turbine engine equipped with a catalytic combustor designed in accordance with a first preferred embodiment of the present invention;

FIG. 2 is a perspective view showing the gas turbine engine;

FIG. 3 is a schematic longitudinal sectional view showing the catalytic combustor;

FIG. 4 is a top plan view showing a second ring employed in the catalytic combustor;

FIG. 5 is a top plan view showing a modified form of the second ring employed in the catalytic combustor; and

FIG. 6 is a schematic longitudinal sectional view showing the catalytic combustor designed in accordance with a second preferred embodiment of the present invention.

### DESCRIPTION OF PREFERRED EMBODIMENTS

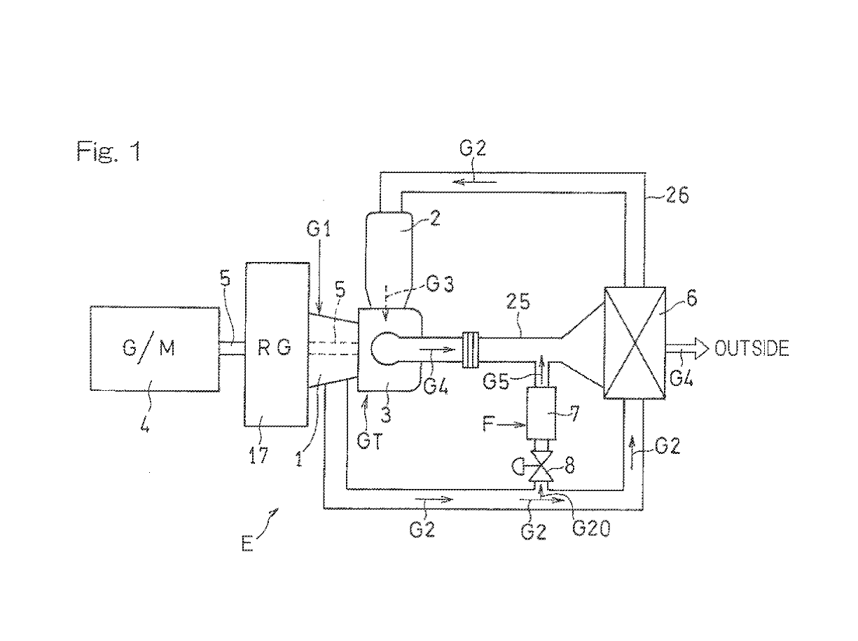

Hereinafter a preferred embodiment of the present invention will be described in detail with reference to the accompanying drawings. A gas turbine engine GT employing the catalytic combustor designed in accordance with the preferred embodiment of the present invention is shown in FIG. 1. The gas turbine engine GT shown therein includes a compressor 1, a catalytic combustor 2 utilizing a catalyst such as, for example, platinum and/or palladium, and a turbine 3. By an output of this gas turbine engine GT, a rotating machine 4, which concurrently serves as an electric power generator and a starter, is driven. The gas turbine engine G and the rotating machine 4 cooperate with each other to define an electric power generating device E.

The gas turbine engine GT is a lean fuel intake gas turbine engine. The lean fuel intake gas turbine engine utilizes as a fuel an inflammable component contained in a working gas of a concentration lower than the inflammability limit concentration. Such a working gas is prepared by mixing a low calorie gas such as, for example, coal mine methane (CMM) emitted in a coal mine, with an air or a ventilation air methane (VAM) or the like, discharged from a coal mine, and the concentration of inflammable component is so adjusted as to be incapable of being burned during compression by the compressor. Then, the working gas is sucked into the engine.

Such a working gas G1 as a mixture of the ventilation air methane (VAM) and the coal mine methane (CMM) is compressed by the compressor 1 to generate a compressed gas G2, and the high pressure compressed gas G2 is supplied to the catalytic combustor 2. This compressed gas G2 is burned as a result of reaction with the catalyst such as, for example, platinum and/or palladium in the catalytic combustor 2 to generate a high temperature, high pressure combustion gas G3, and the combustion gas G3 is supplied to the turbine 3 to drive the latter. The turbine 3 is drivingly connected with the compressor 1 through a rotary shaft 5 and, therefore, the compressor 1 is driven by the turbine 3. The rotary shaft 5 and the rotating machine 4 are drivingly connected with each other through a reduction gear 17. The rotating machine 4 is driven by the rotation of the turbine 3 and, thus, an electric power is obtained. In this way, a electric power generating device E including the gas turbine engine GT and the rotating machine 4 is formed.

The gas turbine engine GT also includes a regenerator (heat exchanger) 6 for heating the compressed gas G2, which is introduced into the catalytic combustor 2 from the compressor 1, by an exhaust gas G4 from the turbine 3, and a warming burner 7 for activating the catalyst by increasing the temperature of the compressed gas G2, which flows into the catalytic combustor 2, by increasing the temperature of the exhaust gas G4 at the time of start. This warming burner 7 mixes a fuel F into an extracted gas G20 partially extracted from the compressed gas G2 which has been compressed by the compressor 1 so as to flow towards the regenerator 6 to flame burn so mixed gas. The resultant warming gas G5 from the warming burner 7 is mixed into the exhaust gas G4, supplied from the turbine 3 to the regenerator 6, thereby to warm the exhaust gas G4. The warming burner 7 is connected with a bleed valve 8 for controlling the amount of supply of the extracted gas G20 towards the warming burner 7.

The regenerator 6 and the catalytic combustor 2 are fluid connected with each other through a downstream side compressed gas passage 26 and, accordingly, the compressed gas G2 is supplied from the regenerator 6 towards the catalytic combustor 2. The turbine 3 and the regenerator 6 are fluid connected with each other through a hollow tubular exhaust duct 25. The exhaust gas G4 flowing from the regenerator 6 is discharged to the outside after having flown through a silencer (not shown).

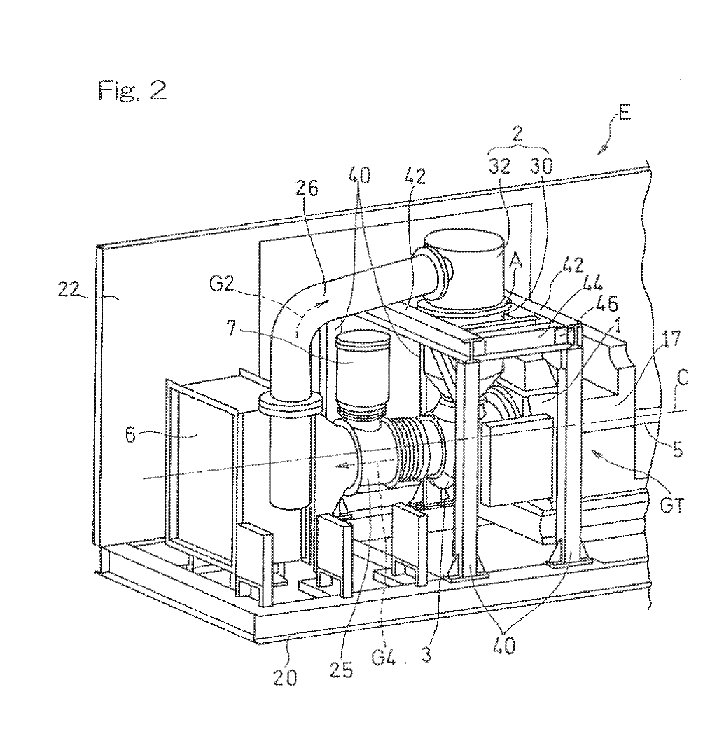

FIG. 2 illustrates a perspective view showing an important portion of the electric power generating device E. As shown therein, the gas turbine engine GT is accommodated within a package 22 in a fashion supported on a base bench 20, the regenerator 6 is fluid connected with one axial end of the turbine 3 with respect to an axial direction C, i.e., a left side as viewed in FIG. 2, through the exhaust duct 25, and the warming burner 7 is fluid connected with an upper portion of the exhaust duct 25. The opposite axial end of the turbine 3 with respect to the axial direction C, i.e., a right side as viewed in FIG. 2, is fluid connected with the compressor 1 and the reduction gear 17 is connected with the opposite end of the compressor 1 remote from the turbine 3. The opposite end of the reduction gear 17 remote from the compressor 1 is connected with the electric power generator 4 (best shown in FIG. 1) through the rotary shaft 5.

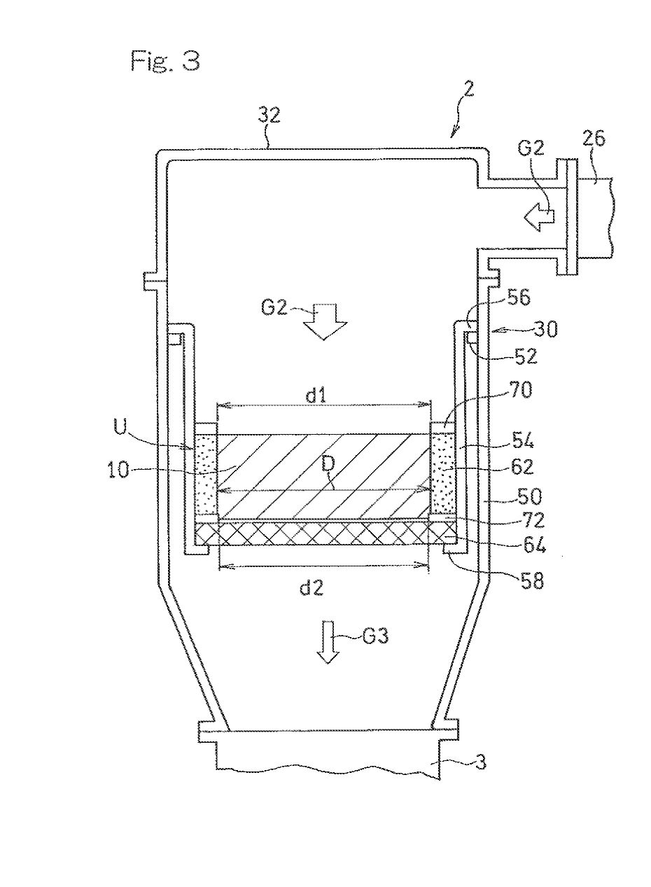

The catalytic combustor 2 is connected with a top portion of the turbine 3. The catalytic combustor 2 and the regenerator 6 are fluid connected with each other through the downstream side compressed gas passage 26 through which the compressed gas G2 is supplied from the regenerator 6 towards the catalytic combustor 2. The catalytic combustor 2 includes a hollow tubular main body 30, in which catalyst unit U is accommodated (as best shown in FIG. 3), and a cylindrical covering body 32 having one end closed and connected with an upper portion of the main body 30 through bolts.

Also, four support posts 40, two on each side of the catalytic combustor 2 with respect to the axial direction C and spaced apart from each other in the axial direction C, are fixedly mounted on the base bench 20. The two support posts 40 on each side of the catalytic combustor 2 are connected with the two support posts 40 on the opposite side of the catalytic combustor 2 by means of respective first connecting members 42 and 42, and neighboring ends of the connecting members 42 and 42 adjacent the support posts 40 are connected with each other by means of respective second connecting members 44 and 44. The first and second connecting members 42 and 44 have respective upper surfaces held substantially in flush with a joint A between the main body 30 and covering body 32 of the catalytic combustor 2.

As shown in FIG. 3, the catalytic combustor 2 is of a single stage design including the catalyst unit U. The main body 30 of the catalytic combustor 2 has a housing 50 which defines the contour thereof, and a lower end portion of the housing 50 is connected with the turbine 3 by means of bolts. The catalyst unit U is removably fitted to the housing 50. In other words, an annular support ring 52 is secured to an inner surface of an upper portion of the housing 50 so as to protrude inwardly of the housing 50, and a cylindrical casing 54 is disposed within the interior of the main body 30. Each of the housing 50 and the casing 54 may not be necessarily limited to the cylindrical shape such as shown and described, but may be of an oval shape or any polygonal tubular shape such as a square shape.

The outer diameter of the casing 54 is so chosen as to be smaller than the inner diameter of the support ring 52. One end portion of the casing 54, that is, an upper end portion as shown in FIG. 3 is formed with a first collar 56 that protrudes radially outwardly and the opposite end portion of the casing 54, that is, a lower end portion as shown in FIG. 3 is formed with a second collar 58 that protrudes radially inwardly. The outer diameter of the first collar 56 is greater than the inner diameter of the support ring 52 and smaller than the inner diameter of the housing 50, and the first collar 56 rests on the support ring 52 and is connected therewith by means of bolts. Accordingly, the casing 54 is removably supported by the housing 50.

The catalyst unit U is such that a columnar catalyst carrier 10 is accommodated within the casing 54 through a catalyst retaining body 62 and, within the interior of the cylindrical casing 54, a columnar support material 64 is accommodated on a downstream side of the catalyst carrier 10. Specifically, an outer peripheral portion of the support material 64 rests on the second collar 58 of the casing 54 and is thereby retained in position. It is to be noted that the catalyst carrier 10 may not be necessarily limited to the columnar shape such as shown and described and may be a prismatic shape in accord with the shape of the casing 54.

The catalyst carrier 10 is of a honeycomb structure having meshes oriented in an axial direction. The annular catalyst retaining body 62 is interposed between the casing 54 and the catalyst carrier 10 so as to seal the compressed gases G2 to be treated from leaking to the outside of the catalyst. The catalyst retaining body 62 is, in a condition wound around the outer periphery of the catalyst carrier 10 so as to be narrowed radially inwardly, inserted inside of the casing 54 and, by the effect of an elastic restoring force of the catalyst carrier 10 and the catalyst retaining body 62, the catalyst retaining body 62 is brought into contact with the inner peripheral surface of the casing 54. At this time, the catalyst retaining body 62 is so set as to be applied with a low contact pressure enough to seal a gas leakage. The support material 64 referred to above is of a structure, in which, for example, a plurality of stainless plates having a major surface oriented in a direction conforming to the direction of flow of the compresses gas G2 are arranged radially, and serves to avoid the movement of the catalyst carrier 10 in the direction of flow of the compresses gas G2.

Annular upstream and downstream side regulating members 70 and 72 are disposed on upstream and downstream sides of the catalyst retaining body 62 with respect to the direction of flow of the compressed gas G2, respectively. The upstream side regulating member 70 is an annular body made of, for example, a stainless material and is fixed to the inner peripheral surface of the casing 54 by means of a fastening member (not shown) such as, for example, bolts which are passed from the outside of the casing 54. The upstream side regulating member 70 serves to avoid passage of the compressed gas G2 through and within the catalyst retaining body 62 and is so designed and so configured as to have a shape and a size both sufficient to cover the entire surface area of an upstream end face of the catalyst retaining body 62. It is noted that in order that the flow of the compressed gas G2 through the catalyst may not be hampered as much as possible, the inner diameter d1 of the upstream side regulating member 70 is preferably so chosen as to be somewhat smaller than the diameter D of the catalyst carrier 10 and, by way of example, the diameter d1 is preferably within the range of 0.98 D to 1.00 D.

The downstream side regulating member 72 is also an annular body made of, for example, a stainless material and is encased within the inner peripheral surface of the casing 54. This downstream side regulating member 72 serves to avoid an undesirable movement of the catalyst retaining body 62 in the direction of flow of the compressed gas G2 by the effect of the difference in pressure of the compressed gas G2 before and after the catalyst. This downstream side regulating member 72 has an inner diameter d2 which is substantially equal to the outer diameter D of the catalyst carrier 10 and, by way of example, the diameter d2 is so set as to be within the range of 1.00 D to 1.02 D.

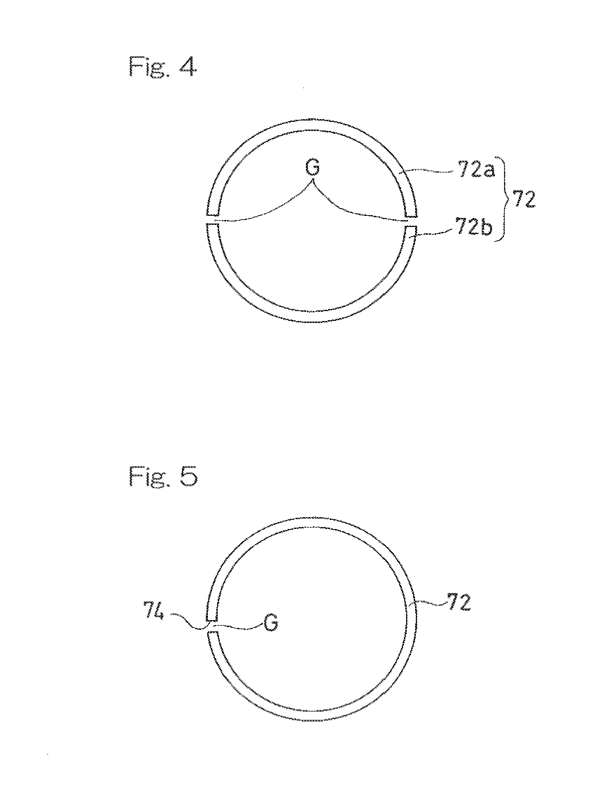

FIG. 4 illustrates a top plan view of the downstream side regulating member 72. As shown therein, the downstream side regulating member 72 is made up of first and second regulating member halves 72a and 72b, which have been divided into two in a peripheral direction, each of the first and second regulating member halves 72a and 72b being disposed in face to face relation to each other while spaced circumferentially with circumferential gaps G and G therebetween. In other words, and those regulating member halves 72a and 72b are so positioned with opposite ends of one of those halves held in face to face relation with the opposite ends of the other of those halves through associated gaps G and G. This downstream regulating member 72 is disposed on the downstream side of the catalyst, at which the temperature becomes high, but the provision of those gaps G between the first and second regulating member halves 72a and 72b allows the thermal expansions to be accommodated.

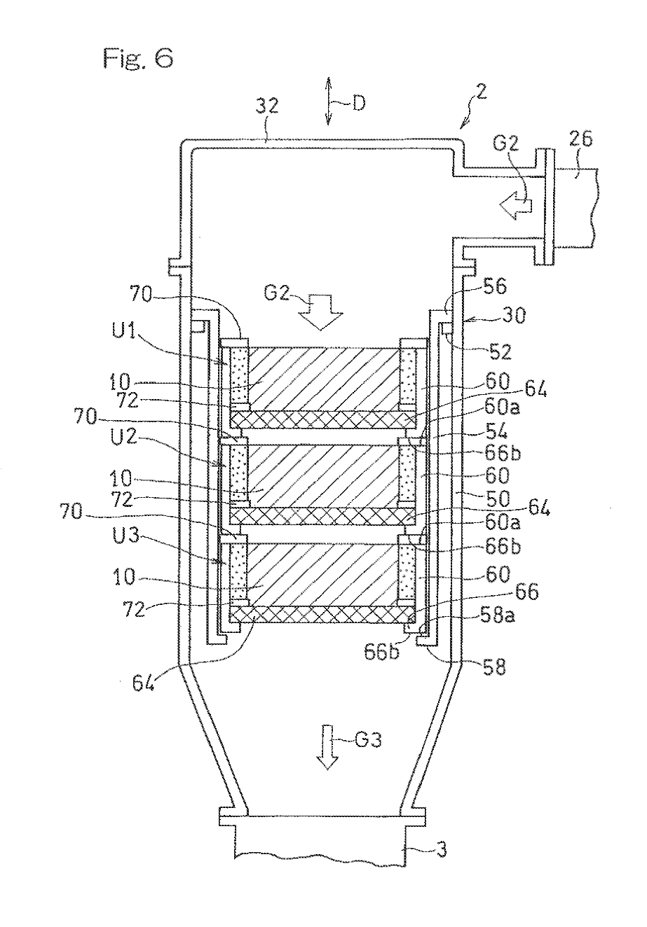

FIG. 5 illustrates a modified form of the downstream side regulating member 72. In this modification, although the downstream side regulating member 72 is not of the divided structure such as shown in and described with reference to FIG. 4, the downstream side regulating member 72 has a circumferential portion thereof depleted to form a cutout 74 defining a single gap G between opposite ends of the downstream side regulating member 72. Even in this modification, the thermal expansion of the downstream side regulating member 72 can be accommodated. Even the upstream side regulating member 70 is of a structure identical with the downstream side regulating member 72 shown in and described with reference to any one of FIGS. 4 and 5.

The operation of the gas turbine engine GT of the structure hereinabove described will be described. At the time of start, since the temperature of the catalytic combustor 2 shown in FIG. 1 is lower than the activation lower limit temperature, the exhaust gas G4 is warmed up by the ignition of the warming burner 7 to allow the regenerator 6 to be warmed. By so doing, the compressed gas G2 flowing through the regenerator 6 is boosted in temperature to cause the catalytic combustor 2 to be heated to a temperature equal to a predetermined temperature at which the catalytic reaction takes place within the catalytic combustor 2. When the rated operation starts, the temperature of the exhaust gas G4 increases, and therefore, the compressed gas G2 supplied from the compressor 1 is heated to a temperature, which is sufficient to allow the catalytic combustor 2 to operate, by the effect of a heat exchange with the exhaust gas G4 within the regenerator 6. As a result, the bleeding valve 8 is closed and the warming burner 7 is therefore halted. At this time, as shown in FIG. 3, the compressed gas G2 flowing into the catalytic combustor 2 flows through and is burned within the catalyst unit U to generate high temperature combustion gases G3, which is subsequently supplied into the turbine 3.

Since the compressed gas G2 flowing through the catalyst carrier 10 is under a high temperature, a large differential pressure is developed between the upstream side (primary side) and the downstream side (secondary side) of the catalyst carrier 10 having the fine meshes. The support material 64 referred to above is used to support the catalyst carrier 10 against such differential pressure and cooperates with the casing 54 and the support ring 52 to avoid an undesirable movement and deformation of the catalyst carrier 10 in the direction of flow of the compressed gas G2.

Also, even in the event that the catalyst retaining body 62 moves in the direction of flow of the compressed gas G2 by the effect of the differential pressure, the downstream side regulating member 72 is disposed between the catalyst retaining body 62 and the support member 64, and therefore, the movement of the catalyst retaining body 62 in the direction of flow of the compressed gas G2 can be avoided. Accordingly, it is possible to avoid a bite of the catalytic retaining body 62, which is made of a resinous material, into the support material 64 in the form of the stainless plate, which would eventually result in damage to the catalyst retaining body 62. Therefore, there is no need to apply a preload to the catalyst retaining body 62 by strongly narrowing the catalyst retaining body 62 radially inwardly and allowing it to contact with the inner peripheral surface of the casing 54 by the effect of its elastic restoring force, in order to prevent the movement of the catalyst retaining body 62 in the direction of flow of the compressed gas G2. In view of this, with the catalyst retaining body 62 having been strongly narrowed the undesirable deformation of the catalyst carrier 10 can be avoided.

Also, since the inner diameter d2 of the downstream side regulating member 72 is substantially equal to the outer diameter D of the catalyst carrier 10, the contact of the downstream side regulating member 72 with a lower portion of the outer peripheral surface of the catalyst carrier 10 can cause the catalyst carrier 10 to be positioned.

Further, the upstream side regulating member 70 prevents the compressed gas G2 from impinging directly upon the catalyst retaining body 62 to thereby prevent a force acting in the direction of flow of the compressed gas G2 from acting on the catalyst retaining body 62 and also to thereby prevent the catalyst retaining body 62 from dropping out from above in the event of occurrence of a surging in the gas turbine engine.

In addition, since the casing 54 is removably supported within the hollow combustor housing 50, after removing the casing 54 out of the housing 50, the catalyst carrier 10 can be removed out of the casing 54 in the outside of the housing 50 so as to achieve replacement of the catalyst carrier 10. Therefore, a work of replacement of the catalyst carrier 10 can be eased.

FIG. 6 illustrates a longitudinal sectional view showing the catalyst combustor 2 designed in accordance with a second preferred embodiment of the present invention. As shown therein, the catalyst combustor 2 is of a multistage design and so far shown in FIG. 6, a three staged design including catalyst units U1, U2 and U3 stacked one above the other in three stages is employed for the combustor 2 in the practice of this second embodiment. One of the catalyst units U1, U2 and U3, which is positioned upstream with respect to the direction of flow of the gas, say, the catalyst unit U1 is used for ignition purpose, and the remaining two catalyst units U2 and U3 are for oxidization or combustion purpose.

Each of those catalyst units U1, U2 and U3 are removably fitted to the housing 50. Specifically, each of those catalyst units U1 to U3 is of a structure in which the columnar catalyst carrier 10 is accommodated within the cylindrical unit case 60 through the catalyst retaining material 62 and, within the interior of the cylindrical unit case 60, the columnar support material 64 is accommodated on the downstream side of the catalyst carrier 10 through the downstream side regulating member 72. More specifically, a collar shaped retaining piece 66 protruding in a radially inward direction is formed in a downstream side end portion of the unit case 60, and an outer peripheral portion of the support material 64 rests on the retaining piece 66 and is retained by the unit case 60.

Each of the catalyst units U1, U2 and U3 has an outer diameter that is somewhat smaller than the inner diameter of the casing 54; each of the catalyst units U1, U2 and U3 is inserted from above into the casing 54; the upstream side regulating member 70 is disposed between the second catalyst unit U2 and the third catalyst unit U3 and also between the first catalyst unit U1 and the second catalyst unit U2; and the upstream side regulating member 70 is also disposed on the upstream side of the catalyst retaining body 62 of the first catalyst unit U1. Only the upstream side regulating member 70, which is positioned topmost, is fixed to the casing 54 through a fastening member (not shown) such as, for example, bolts in a manner similar to that described in connection with the first embodiment and the other upstream side regulating members 70 are encased in the inner peripheral surface of the casing 54.

The third catalyst unit U3, which is positioned on the most downstream side, is retained by the casing 54 with a lower surface 66b of the retaining piece 66 of the unit case 60 thereof held in contact with an upper surface 58a of the second collar 58 of the casing 54. The first and second catalyst units U1 and U2 are supported with respective lower surfaces 66b of the retaining pieces 66 of the unit cases 60 held in contact with the upper end surfaces 60a of the unit cases 60 of the catalyst units U2 and U3. Other structural features than those described above are identical with those shown in and described in connection with the previously described first embodiment and, therefore, even in this second embodiment, effects similar to those afforded by the previously described first embodiment can be obtained.

Also, in the practice of this second embodiment, the retaining pieces 66 of the respective unit cases 60 of the first and second catalyst units U1 and U2 may be made protruding radially inwardly so that the retaining piece 66 can be concurrently used as the upstream side regulating member 70, while the upstream regulating member 70 between the first and second catalyst units U1 and U2 and the upstream side regulating member 70 between the second and third catalyst units U2 and U3 are dispensed with. By so doing, the number of component parts used can be reduced.

Although in describing the second embodiment, reference has been made to the three staged catalytic combustor, the number of the stages may be two or four or more. Also, while in the practice of the foregoing embodiments, the mixture of the coal mine methane and the ventilation air methane has been used as the intake fuel, the present invention is not necessarily limited thereto and may be applied to the standard catalytic combustion type gas turbine engine, in which air is used as the intake air and a fuel is supplied to the catalytic combustor 2.

Although the present invention has been fully described in connection with the preferred embodiments thereof with reference to the accompanying drawings which are used only for the purpose of illustration, those skilled in the art will readily conceive numerous changes and modifications within the framework of obviousness upon the reading of the specification herein presented of the present invention. By way of example, while the casing 54, which is a member separate from the housing 50, may be dispensed with and, instead, a portion of the housing may be used as a casing. Accordingly, such changes and modifications are, unless they depart from the scope of the present invention as delivered from the claims annexed hereto, to be construed as included therein.

### REFERENCE NUMERALS

1 . . . Compressor

2 . . . Main combustor (Catalytic combustor)

3 . . . Turbine

6 . . . Regenerator

10 . . . Catalyst carrier

50 . . . Housing

54 . . . Casing

62 . . . Catalyst retaining body

64 . . . Support material

70 . . . Upstream side regulating member

72 . . . Downstream side regulating member

72a, 72b . . . Regulating member half

74 . . . Cutout

d1 . . . Inner diameter of the upstream side ring body

d2 . . . Inner diameter of the ring body

D . . . Outer diameter of the catalyst carrier

G . . . Circumferential gap

G2 . . . Treated gas (Compressed gas)

GT . . . Gas turbine engine

U, U1, U2, U3 . . . Catalyst unit

What is claimed is:

1. A catalytic combustor for use with the gas turbine engine which comprises:
a catalyst carrier;
a casing to accommodate therein the catalyst carrier;
a catalyst retaining body interposed between the casing and the catalyst carrier, the catalyst retaining body retaining an outer peripheral surface of the catalyst carrier against an inner peripheral surface of the casing and also preventing gases to be treated from leaking in a downstream direction through an outer periphery of the catalyst carrier;
a support material disposed on an downstream side of the catalyst carrier in a direction conforming to a direction of flow of the gases to be treated, the support material supporting the catalyst carrier; and
a downstream side regulating member disposed on a downstream side of the catalyst retaining body, the downstream side regulating member preventing the catalyst retaining body from moving in the direction of flow of the gases.

2. The catalytic combustor as claimed in claim 1, wherein the downstream side regulating member is annular in shape and the catalyst carrier is columnar in shape, the downstream side regulating member having an inner diameter that is substantially identical with the outer diameter of the catalyst carrier.

3. The catalytic combustor as claimed in claim 1, wherein the downstream side regulating member body comprises first and second regulating member halves that are divided into two in a peripheral direction, each of the first and second regulating member halves being disposed in face to face relation to each other while spaced circumferentially.

4. The catalytic combustor as claimed in claim 1, wherein the downstream side regulating member has a cutout defined in a portion thereof in a circumferential direction and a circumferential gap is provided in the cutout.

5. The catalytic combustor as claimed in claim 1, further comprising an upstream side regulating member disposed on an upstream side of the catalyst retaining body in the direction of flow of the gases, the upstream side regulating member being operable to avoid a passage of the gases to be treated within the catalyst retaining body.

6. The catalytic combustor as claimed in claim 5, wherein the upstream side regulating member has an inner diameter that is chosen to be somewhat smaller than the outer diameter of the catalyst carrier.

7. The catalytic combustor as claimed in claim 1, wherein the casing is removably supported inside of a hollow combustor housing.
